(19) United States
(12) Patent Application Publication
(10) Pub. No.: US 2026/0301031 A1
(43) Pub. Date: Oct. 1, 2026

(54) SYSTEM AND METHOD FOR USING AND REGISTERING CONSUMER PRODUCTS

(71) Applicant: 2SURV, INC., Austin, TX (US)

(72) Inventors: Russell W. White, Austin, TX (US); Shawn A. Roberts, Temple, TX (US)

(21) Appl. No.: 19/095,997

(22) Filed: Mar. 31, 2025

(51) Int. Cl. G06Q 30/02; H04W 4/80

(52) U.S. Cl. CPC G06Q 30/0281; H04W 4/80

(57) ABSTRACT

A system and method to facilitate using and registering consumer products is disclosed. A designer may maintain an online resource that includes a registration page for a consumer product and a video depicting use of the product. The designer may write instructions and data to a chip included within a passive near field communication (NFC) device to request access to the online resource. The NFC device may be passive and may include an adhesive layer, a first and second plastic layer, and a chip with an antenna coiled around the chip sandwiched between and encased by the first and second layer of plastic. The designer may adapt the NFC device to an exterior surface of a consumer product. At some point, a user may use a smartphone having an NFC reader to communicate with the NFC device and to access the online resource that includes the registration page.

### FIELD OF THE DISCLOSURE

The present disclosure relates to consumer products and, more specifically, to a system and method to facilitate using and registering consumer products.

### BRIEF SUMMARY

According to one aspect, a cooler, includes: a base; an exterior surface extending upward from the base; a top that may be opened and closed; a sidewall; an enclosure portion accessible when the top is opened; a beverage silo located within the enclosure, the beverage silo configured to at least partially form a generally cylindrical void configured to hold an insulated tumbler; a port hole formed through the sidewall; a mating plug located at the bottom of the beverage silo and connected to a spigot accessible from outside the enclosure portion and having a flow control mechanism; the flow control mechanism operable to stop a flow of a beverage when the flow control mechanism is in a closed position and to allow the flow of the beverage when the flow control mechanism is in an opened position; and a near field communication device adapted to the exterior surface.

In one implementation, the cooler further comprising the insulated tumbler, where the insulated tumbler is generally cylindrical in shape having an exterior formed of a rigid material, further wherein an interior volume of the insulated tumbler is at least 32 fluid ounces. The cooler may further include: a first toting strap; and a second toting strap, where the first toting strap and the second toting strap form a soft-sided backpack cooler. The flow control mechanism may include a push button to facilitate transitioning from the closed position to the opened position. The cooler may further include a removable replacement lid for the insulated tumbler, where the removable replacement lid includes an adapter plug configured to releasably connect to the mating plug to form a leak-proof coupling. The adapter plug may include a spring-loaded stop valve that is opened when the adapter plug is releasably connected to the mating plug.

In an implementation, the cooler has an external height dimension of over twenty inches, an external depth dimension of over nine inches, and an external width dimension of sixteen inches.

According to another aspect, a system to carry things includes: a cooler having a base, a top, and a sidewall with an external surface; a passive near field communication sticker attached to the exterior surface, the passive near field communication sticker including a rewritable memory, an integrated circuit, and an antenna.

In one implementation, the cooler has a hinging top for gaining access to an interior portion of the cooler and the rewritable memory stores instructions operable to communicate a website link to a smartphone capable of near field communication and located within four centimeters of the near field communication sticker. The system may further include a logo patch attached to the exterior surface such that the near field communication sticker is located between the exterior surface and the logo patch. The system may also include: a packaging material at least partially surrounding the cooler; and a second near field communication sticker attached to the packaging material.

According to yet another aspect, a method to use a consumer product includes: maintaining an online resource that includes a registration page for the consumer product and a video depicting use of the consumer product; writing instructions and data to a chip included within a passive near field communication sticker to request access to the online resource; and attaching the near field communication sticker to an exterior surface of the consumer product.

In one implementation, the consumer product is a cooler. Or, the consumer product can be selected from a group consisting of a cooler, a piece of furniture, an alcoholic beverage container, an insulated tumbler, a boating product, and an unassembled product.

In an implementation, the method further includes attaching a second near field communication sticker to a packaging component for the consumer product. The method may also include attaching a logo to the consumer product such that the near field communication sticker is at least partially located between the exterior surface and the logo.

### BACKGROUND

Consumers, businesses, and other groups often shop for and buy consumer products either online or at retail locations. Occasionally, it is difficult to know exactly how to use and/or care for these products. Similarly, many product suppliers encourage purchasers to register products, and this process can be time consuming and annoying. Moreover, product manufacturers frequently include a collection of papers within the packaging of the product. These papers may include instructions, contact information, warranty information, etc. As often as not, these papers are lost or thrown away. As such, both producers and customers alike could benefit from systems and methods that facilitate using and registering consumer products.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a system that incorporates teachings of the present disclosure to facilitate the use of a consumer product.

FIG. 2 illustrates a backpack style cooler that incorporates teachings of the present disclosure.

FIG. 3 illustrates a front view and a cross-sectional side view of a soft-sided backpack style cooler and refillable container system incorporating teachings of the present disclosure.

FIG. 4 illustrates a system and a graphical user interface incorporating teachings of the present disclosure.

### DETAILED DESCRIPTION

The following discussion is intended to provide one skilled in the art with various teachings that can be combined and/or separated to create useful and/or desirable products. The teachings can be employed in a variety of settings. For example, a designer could use these teachings to create an automobile-oriented, boat-oriented, and/or other vehicle-oriented product. Additionally, a designer may want to employ many of these teachings to accompany power tools, electronic devices, furniture, beverages, coolers, storage devices, consumer devices for sale at big box stores, products for sale online, products sold to business, products sold to individuals, etc.

While there are many opportunities for designers to use the teachings disclosed herein, the majority of this detailed description section will focus on embodiments designed for a soft-sided cooler that typically utilizes ice cubes or other frozen objects to facilitate keeping various beverage containers at a desired and chilled temperature. The decision to focus on this implementation is not intended to limit the scope of the teachings, but rather to facilitate a clear presentation of the teachings.

Devices that maintain multiple beverage containers at or near some desired temperature tend to be of two types: hard-sided insulated containers or soft-sided insulated containers. Hard-sided portable insulated containers tend to be made of molded plastic, with an inner layer, or wall, and an outer layer or wall, with an insulation space between. Hard-sided containers are rigid and frequently very heavy. They also tend to be bulky and difficult to carry. A soft-sided cooler, by contrast, can rely on an external wall structure that is not substantially rigid. The wall structure may incorporate a multi-layer design that includes an outside layer of webbing or fabric, an inside layer of waterproof webbing or fabric, and a flexible insulation layer positioned between the inner and outer layers. A designer will recognize that layers may be added or removed to meet certain objectives. In some embodiments, a soft-sided cooler may include a rigid or semi-rigid element to give the cooler some stability and to help the cooler maintain a given shape or protect items inside the cooler.

Throughout this description, containers may be referred to as “coolers.” Similarly, the portion of the container that opens and closes to facilitate accessing multiple beverage containers stored within the container will typically be referred to as the top of the container. As such, the base panel will typically be referred to as the bottom. The multiple layers that may make up the side walls may be a sandwich of various components. For example, a middle insulating layer may include a flexible or resilient layer of a relatively soft and flexible foam. As noted above, sidewall elements of the cooler may have insulating properties such that heat transfer across the panel is limited. An example of a potential panel construction is an internal core of foam such as closed cell polyurethane foam. The insulating foam is in turn received between a protective, potentially waterproof layer provided on the interior of the container and a potentially decorative layer of polymer sheeting, such as nylon sheeting on the exterior. In order to maintain the soft-sided characteristics of some embodiments, at least the sidewalls may be formed to be pliable.

To be clear, potential insulated coolers incorporating the teachings of this disclosure may be used to carry cold items such as soda, beer, sandwiches, ice cream, meat, and so on. Alternatively, the insulated coolers can be used to transport hot items such as casseroles, lasagna, vegetables, etc.

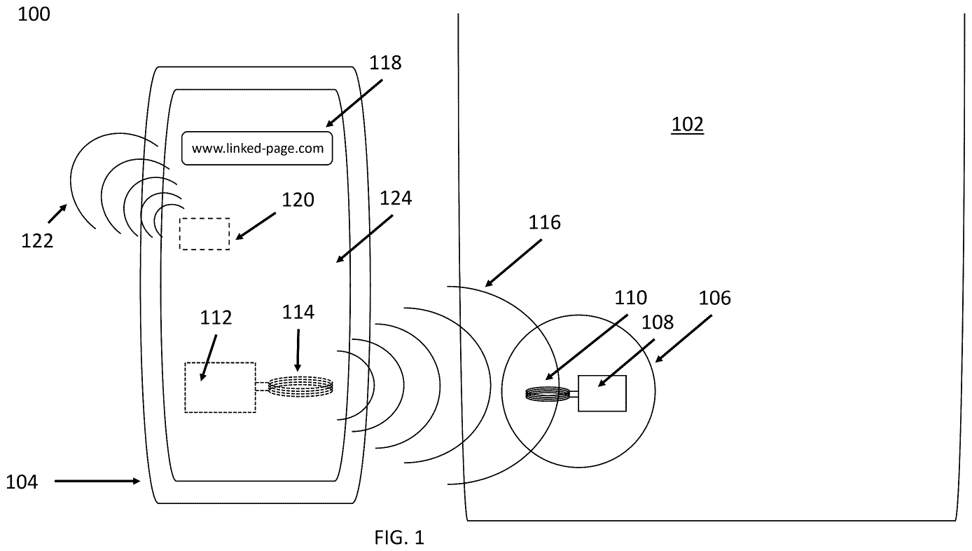

With that said and as mentioned above, FIG. 1 depicts a system 100 that incorporates teachings of the present disclosure to facilitate the use of a consumer product. As depicted, consumer product 102 is generally depicted as a rectangular object. In practice, product 102 could be a cooler, a piece of furniture, a tool, a vehicle, or some other product. Similarly, product 102 could still be within its packaging, such as a cardboard box. As such, the depicted surface of product 102 may be packaging material.

A wireless device 104 is also depicted in system 100. In practice, device 104 may be a cellular telephone, a tablet, or some other electronic device with wireless communication capabilities. Referring back to product 102, a near field communication (NFC) sticker 106 is shown attached to product 102. Included as part of sticker 106 may be an NFC chip 108 and an antenna 110. In practice, chip 108 may include a memory storing data and processing commands. Antenna 110 is depicted as being next to chip 108, but it may also be wrapped around chip 108 in some embodiments. In operation, antenna 110, which may be a thin coil of wire, may assist in powering chip 108 and allow for communication with other NFC-enabled devices. Sticker 106 may effectively create an encasement of chip 108 and antenna 110 within a durable material. Sticker 106 may also have an adhesive back to facilitate sticking it onto appropriate surfaces.

In practice, NFC technology may allow wireless communication over short distances and may operate within the radio frequency (RF) spectrum at 13.56 MHz. In practice, when an NFC-enabled device, like device 104, comes close to an NFC sticker, like sticker 106, a magnetic field 116 may be created. As depicted, device 104 includes a chip 112 communicatively coupled to an antenna 114. In the depicted system 100, chip 112 may be powered by a battery within device 104. By contrast, sticker 106 and chip 108 may not be powered or have access to a power source or battery within product 102. In fact, in some cases, product 102 may not have any sort of onboard power supply.

As such and in operation, chip 112 and antenna 114 may be powered and may create a magnetic field as a result of electricity running through the loops of antenna 114. Magnetic field 116 may induce a current to begin moving through the coils of antenna 110 and activate chip 108 within sticker 106, powering it up and allowing data transfer between sticker 106 and the device 104.

Sticker 106, once powered by electromagnetic field 116, may transmit data stored in chip 108 to device 104. This data may be simple text, a URL, or some information or commands. In operation, holding device 104 near sticker 106 could generate a prompt 118, which might be a soft button presented within a graphical user interface presented on a screen 124 of device 104. Prompt 118 could be a touchable soft button presented on a touch screen display that initiates the opening of a web browser and the requesting of a website. Similarly, prompt 118 could initiate a phone call, launch an app, and/or cause some other actions depending on how sticker 106 is programmed.

In practice, a developer can encode sticker 106 with a wide range of data, including links to websites, digital business cards, social media profiles, Wi-Fi network credentials, or even custom apps and automation scripts. This programming can be done using various NFC writing apps available on smartphones, making it a user-friendly process.

As depicted, device 104 includes a wide area wireless chip 120, which may allow device 104 to communicate using RF signals 122 across a larger distance and to retrieve, for example, website data that may be linked with prompt 118. In some circumstances, a user may have purchased a new consumer product, like product 102. A seller and/or developer of product 102 may have a product registration option, a collection of use and/or care instructions, a series of useful videos for the product 102, etc. To facilitate a user gaining access to these resources, the developer may include instructions in chip 108 that make it easy for a user's smartphone to communicate with sticker 106, for the user to see prompt 118 on the user's smartphone, to select prompt 118, and to be taken to an online resource to access product registration, videos, user guides, assembly instructions, etc. The online resource may maintain different kinds of information depending upon the product represented by product 102. If product 102 is a piece of furniture or a product that requires assembly like a bicycle or a gas grill, the resource may maintain assembly instructions and/or videos. If the product is a bottle of wine, the resource may maintain rating information and/or tasting notes.

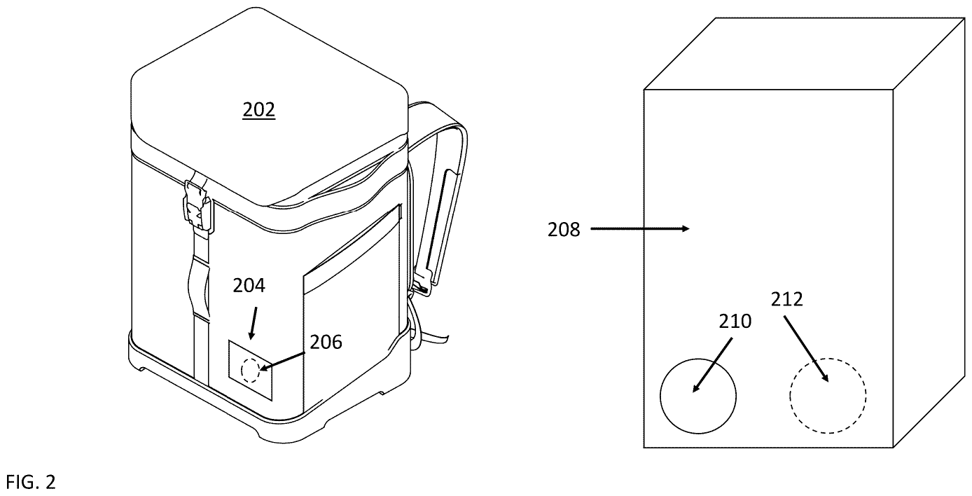

As mentioned above, FIG. 2 illustrates a system 200 that includes a backpack style cooler 202 that incorporates teachings of the present disclosure. As depicted, cooler 202 includes a logo 204 attached to a front surface of cooler 202. Sandwiched between an exterior surface and logo 204 is an NFC sticker 206. Sticker 206 may be a listener target in that it may not have access to its own power source like sticker 106. Sticker 206 may allow a purchaser of cooler 202 to gain access to online resources for cooler 202. For example, a developer may include instructions in the chip of sticker 206 that make it easy for a user to scan sticker 206, see a prompt on the user's smartphone, select the prompt, and be taken to an online resource to access product registration, videos, user guides, assembly instructions, etc.

In some embodiments, cooler 202 may be packaged and shipped within a box 208. As shown, box 208 may have its own NFC sticker 210, which may provide the type of information and access to information that a potential buyer might be interested in knowing. For example, sticker 210 may provide and/or provide access to information that shows images of cooler 202, color of cooler 202, use cases for cooler 202, what is inside the box information for cooler 202, etc. Similarly, sticker 210 may “send” the potential and curious customer to a website that maintains a counter of how many people have activated sticker 210, how many customers converted on buying cooler 202, how long a customer considered the information accessed with sticker 210, etc.

As depicted, cooler 202 has a sticker 206, and box 208 has its own sticker 210. In practice, stickers 206 and 210 may provide access to the same and/or different information. For example, sticker 210 may provide access to use videos but no access to product registration pages. Similarly, sticker 206 may provide access to both use videos and product registration pages.

A designer may not want random shoppers to “register” a product they did not actually buy. As such, a designer may elect, as depicted in FIG. 2, to have sticker 210 on the left front of box 208 and sticker 206 on the right front of cooler 202. Additionally, as seen, the designer may elect to include a shielding component 212 on box 208. Component 212 may be placed on box 208 on an inside surface, an outside surface, between layers of box 208 or somewhere else. In practice, component 212 may include layers of aluminum, carbon fiber, copper, mu-metal, nickel, iron, molybdenum, soft magnetic alloys, etc. to block radio frequencies at or around 13.56 MHz frequencies. As such, a user would be able to connect with sticker 210 and access certain information. But, the same user may be blocked from connecting with sticker 206 by shielding component 212. This blocking might help keep a shopper from gaining access to a registration page for a product the shopper may not buy.

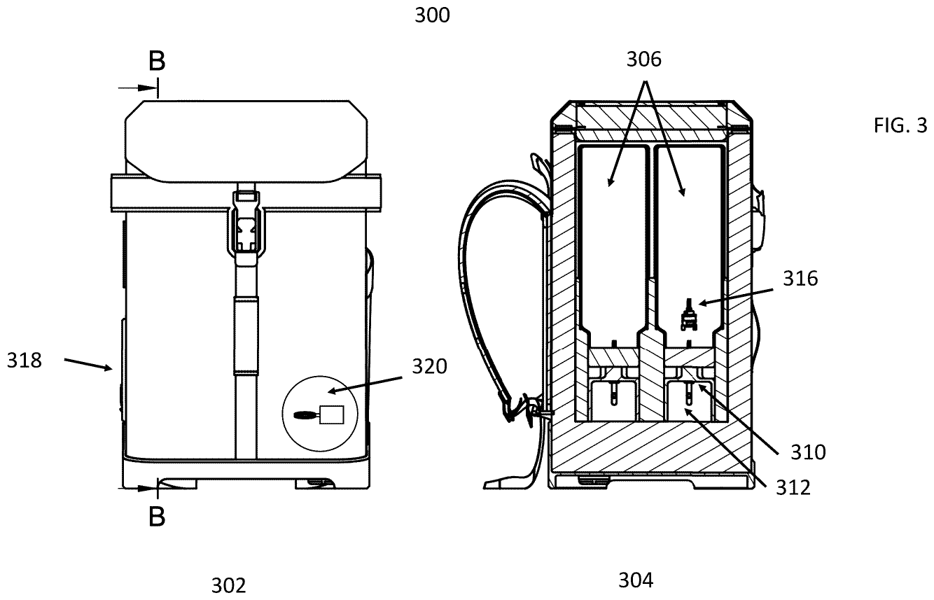

As mentioned above, FIG. 3 illustrates a front view 302 and a cross-sectional side view 304 (with the cross section formed at surface “B”) of a soft-sided backpack style cooler and refillable container system 300 incorporating teachings of the present disclosure. As depicted, system 300 provides a cut away view 304 of two beverage sleeves, formed as two silos 306, each designed to accept and maintain an insulated tumbler that may be storing a beverage. As depicted, silos 306 are located inside. Also, on the inside are mating plugs 310 and tubes 312. In practice, a user may remove a lid from an insulated tumbler and replace it with a tap cap lid. The tumbler with a tap cap lid may be inverted and inserted into one of silos 306 to mate with one of mating plugs 310. The tap cap lid may include an adapter plug 316 (shown without the tap cap lid or tumbler). The beverage inside the tumbler may then be able to pass through the adapter plug 316 of the tap cap lid, through a hole within mating plug 310 and into tube 312, which is connected to plug 310. Tube 312 may be routed to and/or through a port to a dispensing region, which may allow the beverage inside the tumbler to makes its way from the inside of a container to a dispensing port, which may be located on or near an outside wall surface 318. Depending upon designer concerns, the dispensing port may be controlled by any number of devices, such as a push-button operated stopcock or spigot.

As system 300 is a fundamentally new form of a cooler, a user may not be readily aware of how to use it effectively. As such, a designer may attach an NFC sticker 320 to an exterior and/or user-accessible surface. In some cases, the sticker may be “hidden” behind a branded logo of cooler 202 and may be passive or powerless. Without having its own power, sticker 320 may rely on inductive coupling and a current induced in its coiled antenna from a magnetic field created by the powering of a separate but proximally located coil.

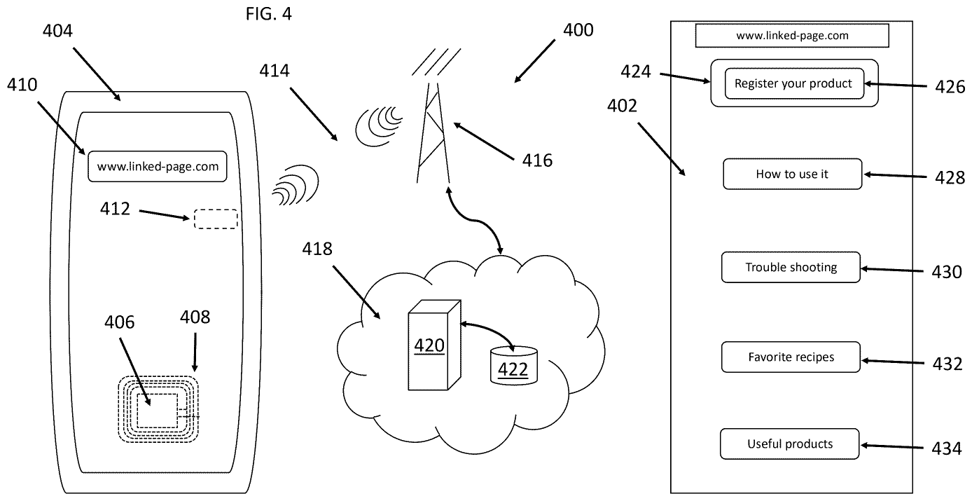

As mentioned above, FIG. 4 illustrates a system 400 and a graphical user interface 402 incorporating teachings of the present disclosure. As depicted, smartphone 404 may have already communicated with an NFC sticker, like sticker 320, using chip 406 and antenna 408. As a result, smartphone 404 is presenting a soft button 410 capable of initiating the requesting of remotely stored information. As shown, wide area wireless transceiver 412 may be capable of using cellular data communications 414 to communicate with a component 416 of a cellular data network. In practice, component 416 may be communicatively coupled to a data network 418 with a server 420 and data storage 422. In practice, this system may include components of the world wide web.

As a result of the request issued by smartphone 404, a user may be presented with user interface 402 on the touch screen of smartphone 404. As depicted, user interface 402 includes several soft buttons linked to remote resources for different kinds of information. As depicted “Register your product” includes an indicator 424, which may indicate that the user has already registered the product. If the user had not already registered the product, selecting soft button 426 may initiate the sending of a request to access a registration resource. In practice, the user may, in some scenarios, still select soft button 426 to, for example, change the user's contact information, check registration, initiate warranty claims, etc.

Referring back to interface 402, a user may see and select soft button 428 to initiate the sending of a request to access use videos, user manuals, etc. Similarly, a user may see and select soft button 430 to initiate the sending of a request to access trouble shooting videos and FAQs. A user may see and select soft button 432 to initiate the sending of a request to access a recipe book. For example, with a fundamentally new cooler like the one depicted in FIG. 3, a user may want to fill tumblers with cocktails to be later dispensed by the cooler. As such, the maker of the cooler may maintain a list of great cocktails with recipes and/or videos on how to prepare those cocktails. Selecting soft button 432 may give a user access to that content. User interface 402 also includes soft button 434, which a user may see and select soft button to initiate the sending of a request to access a shopping page with a collection of products that may be purchased online.

A designer will recognize that the layout, the content, the type and number of soft buttons, etc. utilized in a user interface like interface 402 may be changed to suit the designer's needs. Similarly, materials, volumes, sizes, connection types, and coating options, may be designer dependent and may be altered without departing from the spirit of this disclosure. For example, the phrase “sticker” is used frequently above, but this may not require such a component to have an adhesive layer. A sticker, could be, for example, a chip and an antenna encased between an upper and a lower clear, plastic sheet. It may also have an adhesive layer, but that may not be necessary all of the time.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

While the present invention has been described with respect to a limited number of embodiments, those skilled in the art will appreciate numerous modifications and variations therefrom. It is intended that the appended claims should cover any such modifications and variations as fall within their true spirit and scope.

1. A cooler, comprising:
a base;
an exterior surface extending upward from the base;
a top that may be opened and closed;
a sidewall;
an enclosure portion accessible when the top is opened;
a beverage silo located within the enclosure, the beverage silo configured to at least partially form a generally cylindrical void configured to hold an insulated tumbler;
a port hole formed through the sidewall;
a mating plug located at the bottom of the beverage silo and connected to a spigot accessible from outside the enclosure portion and having a flow control mechanism;
the flow control mechanism operable to stop a flow of a beverage when the flow control mechanism is in a closed position and to allow the flow of the beverage when the flow control mechanism is in an opened position; and
a near field communication device adapted to the exterior surface.

2. The cooler of claim 1, further comprising the insulated tumbler, wherein the insulated tumbler is generally cylindrical in shape having an exterior formed of a rigid material, further wherein an interior volume of the insulated tumbler is at least 32 fluid ounces.

3. The cooler of claim 1, further comprising:
a first toting strap; and
a second toting strap, wherein the first toting strap and the second toting strap form a soft-sided backpack cooler.

4. The cooler of claim 1, wherein the flow control mechanism comprises a push button to facilitate transitioning from the closed position to the opened position.

5. The cooler of claim 2, further comprising a removable replacement lid for the insulated tumbler, wherein the removable replacement lid includes an adapter plug configured to releasably connect to the mating plug to form a leak-proof coupling.

6. The cooler of claim 5, wherein the adapter plug includes a spring-loaded stop valve that is opened when the adapter plug is releasably connected to the mating plug.

7. The cooler of claim 1, wherein the cooler has an external height dimension of over twenty inches, an external depth dimension of over nine inches, and an external width dimension of sixteen inches.

8. A system to carry things, comprising:
a cooler having a base, a top, and a sidewall with an external surface;
a passive near field communication sticker attached to the exterior surface, the passive near field communication sticker including a rewritable memory, an integrated circuit, and an antenna.

9. The system of claim 8, wherein the cooler has a hinging top for gaining access to an interior portion of the cooler and the rewritable memory stores instructions operable to communicate a website link to a smartphone capable of near field communication and located within four centimeters of the near field communication sticker.

10. The system of claim 8, further comprising a logo patch attached to the exterior surface such that the near field communication sticker is located between the exterior surface and the logo patch.

11. The system of claim 8, further comprising:
a packaging material at least partially surrounding the cooler; and
a second near field communication sticker attached to the packaging material.

12. A method to use a consumer product, comprising:
maintaining an online resource that includes a registration page for the consumer product and a video depicting use of the consumer product;
writing instructions and data to a chip included within a passive near field communication sticker to request access to the online resource; and
attaching the near field communication sticker to an exterior surface of the consumer product.

13. The method of claim 12, wherein the consumer product is a cooler.

14. The method of claim 12, wherein the consumer product is selected from a group consisting of a cooler, a piece of furniture, an alcoholic beverage container, an insulated tumbler, a boating product, and an unassembled product.

15. The method of claim 12, further comprising attaching a second near field communication sticker to a packaging component for the consumer product.

16. The method of claim 12, further comprising attaching a logo to the consumer product such that the near field communication sticker is at least partially located between the exterior surface and the logo.
